(19) United States
(12) Patent Application Publication
(10) Pub. No.: US 2016/0176296 A1
(43) Pub. Date: Jun. 23, 2016

(54) SYSTEMS AND METHODS FOR REGENERATIVE DYNAMIC BRAKING

(71) Applicant: Electro-Motive Diesel, Inc., LaGrange, IL (US)

(72) Inventor: Edward Joseph Gawel, JR., Woodridge, IL (US)

(73) Assignee: Electro-Motive Diesel, Inc., LaGrange, IL (US)

(21) Appl. No.: 14/578,620

(22) Filed: Dec. 22, 2014

(51) Int. Cl. B60L 7/02; B60L 7/10; B60L 11/02; B60L 1/00; H02P 3/14; H02P 3/12

(52) U.S. Cl. CPC B60L 7/02; H02P 3/14; H02P 3/12; B60L 11/02; B60L 1/00; B60L 7/10

(57) ABSTRACT

A regenerative braking system includes a converter having a converter output and a converter input. The converter input is electrically connected to a traction motor. The system also includes a resistive grid electrically connected to the converter output. The resistive grid includes at least one grid resistor. The system includes a tap electrically coupled in parallel between the at least one grid resistor and a direct-current power bus.

### TECHNICAL FIELD

This disclosure relates generally to traction motor drive systems and, more specifically, to systems and methods for regenerative dynamic braking of a locomotive.

### BACKGROUND

During dynamic braking, traction motors may function as generators to slow the movement of the locomotive by converting the kinetic energy of the locomotive into electrical energy. In rheostatic dynamic braking, grid resistors can be incorporated to dissipate the generated electrical energy as heat. As dynamic braking operations are performed, the temperature of the grid resistors may increase and may be cooled using a grid blower. Not only is this a waste of the power generated by the traction motors, but it also requires expending power to operate the grid blower used to prevent the grid resistors from overheating. For fuel efficiency and environmental purposes, rather than waste the energy generated by the traction motors, it may be advantageous to use the electrical energy to at least partially power the locomotive and its subsystems.

One solution for using the electrical energy generated by the traction motors is described in U.S. Pat. No. 8,179,084 (“the '084 patent”). The '084 patent is directed to a drive system for a grid blower used to cool the grid resistors. According to the '084 patent, the blower is powered by a motor that is coupled to taps across the grid of resistive elements. As such, the blower operates whenever there is electrical power on the grid of resistive elements, or grid resistors, such as during a dynamic braking operation. Since the blower is directly powered by electrical power from the grid resistors, additional electrical power need not be generated specifically to power the blower.

The '084 patent provides only a limited solution in which the grid blowers are powered with the electricity generated by the traction motors. The '084 patent only provides a solution for the grid blower to be powered directly from the resistive elements. However, as grid resistors can generate more electricity than is used to operate the grid blower, a solution is needed to enable other systems to use the electricity generated by the traction motors.

The presently disclosed systems and methods are directed to overcoming one or more of the problems set forth above and/or other problems in the art.

### SUMMARY

According to one aspect, this disclosure is directed to a regenerative braking system. The system may include a converter having a converter output and a converter input. The converter input may be electrically connected to a traction motor. The system may also include a resistive grid electrically connected to the converter output. The resistive grid may include at least one grid resistor. The system may also include a tap electrically coupled in parallel between the at least one grid resistor and a direct-current power bus.

In accordance with another aspect, this disclosure is directed to a locomotive. The locomotive may include an axle and a pair of wheels connected to the axle. The locomotive may also include a traction motor rotatably coupled to the axle. The locomotive may also include a regenerative braking system. The system may include a converter having a converter output and a converter input. The converter input may be electrically connected to the traction motor. The system may also include a resistive grid electrically connected to the converter output. The resistive grid may include at least one grid resistor. The system may also include a tap electrically coupled in parallel between the at least one grid resistor and a direct-current power bus of the locomotive.

According to another aspect, this disclosure is directed to a method. The method may include dynamically braking a traction motor, thereby resulting in an alternating current. The method may include converting the alternating current into a direct current and supplying the direct current to a resistive grid to dissipate a first portion of the direct current. The method may also include tapping into the resistor grid to draw a second portion of the direct current and supplying the second portion of the direct current to an electrical output.

### BRIEF DESCRIPTION OF THE DRAWINGS

FIG. 1 provides an exemplary embodiment of a locomotive.

FIG. 2 is a schematic of an exemplary embodiment of a regenerative dynamic braking system.

FIG. 3 is flowchart of an exemplary regenerative braking method.

### DETAILED DESCRIPTION

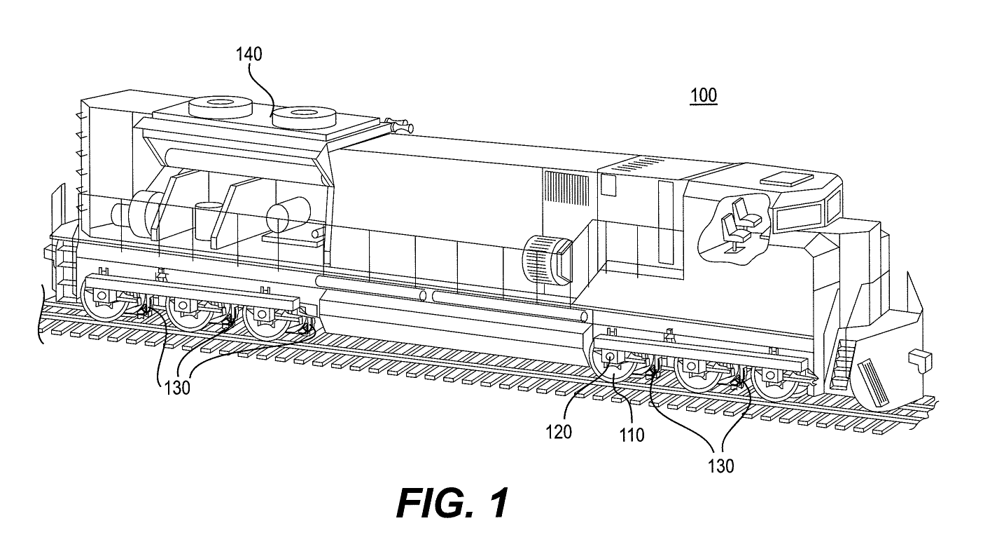

FIG. 1 shows an exemplary vehicle, for example, a locomotive 100, in which systems and methods for regenerative dynamic braking may be implemented. Locomotive 100 may be any electrically powered rail vehicle employing alternating-current traction motors for propulsion. According to the exemplary embodiment illustrated in FIG. 1, locomotive 100 may include a pair of wheels 110 connected to an axle 120 that is rotatably coupled to a traction motor 130. According to some embodiments, traction motor 130 may include a three-phase wound-rotor synchronous machine. Traction motors 130 may be powered by an engine 140 of locomotive 100. During powering of exemplary locomotive 100, traction motor 130 may operate in a driving mode to propel locomotive 100. Additionally or alternatively, traction motor 130 may operate in a dynamic braking mode to slow and/or stop locomotive 100. According to some embodiments, locomotive 100 may include a system 200 for regenerating energy from one or more traction motors 130.

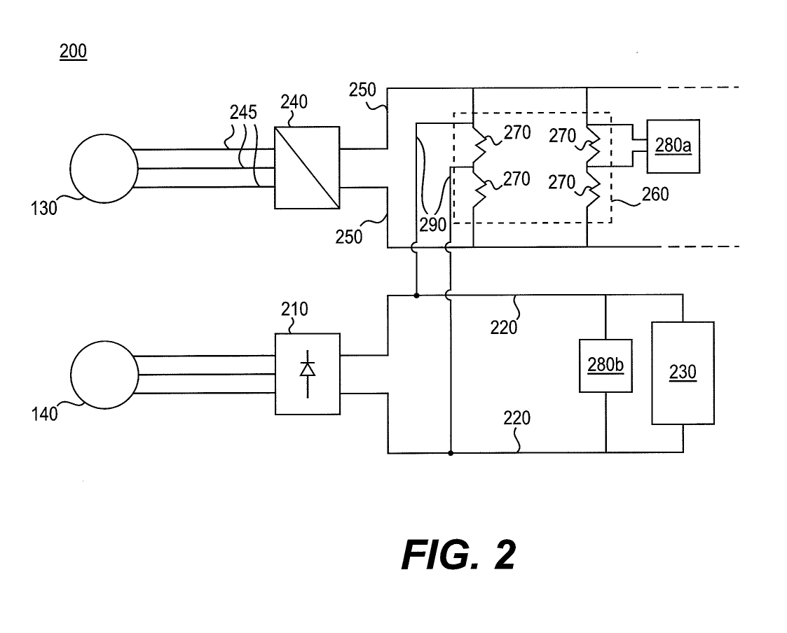

FIG. 2 is a schematic of an exemplary embodiment of regenerative dynamic braking system 200 that may be incorporated into and/or used with locomotive 100. As shown schematically in FIG. 2, system 200 may include a main power source, such as engine 140. According to some embodiments, engine 140 may be configured to power locomotive 100. For example, engine 140 may be configured to supply power to traction motor 130. System 200 may optionally include an auxiliary rectifier 210 to convert an alternating current from engine 140 to direct current that may be used to power other components and/or systems of locomotive 100. For example, a direct-current power bus 220 may be electrically connected to auxiliary rectifier 210. System 200 may include direct-current power bus 220 configured to draw power from engine 140. Additionally or alternatively, system 200 may be configured to supply direct current to direct-current power bus 220, such as from traction motor 130. Direct-current power bus 220 is configured to supply power to an auxiliary load 230. For example, auxiliary load 230 may include one or more subsystems of locomotive 100, such as an engine cooling system and a locomotive control system.

When traction motor 130 is operating in a dynamic braking mode, traction motor 130 may operate as a generator. For example, as shown in FIG. 2, traction motor 130 may be configured to generate a three-phase alternating current when traction motor 130 is operating in a dynamic braking mode. System 200 may be configured to convert the alternating current produced by traction motor 130 into direct current.

For example, system 200 may include a converter 240 having a converter input 245 and a converter output 250. Traction motor 130 may be electrically connected to converter input 245. Converter 240 may be configured to convert the alternating current of traction motor 130 into a direct current, which may flow at converter output 250.

System 200 may also include a resistive grid 260 electrically connected to converter output 250. Resistive grid 260 may be configured to dissipate at least a portion of the direct current across converter output 250. Resistive grid 260 may include at least one grid resistor 270. As grid resistor 270 of resistive grid 260 draws direct current from converter output 250, resistor 270 may overheat. To prevent or decrease the likelihood of overheating, system 200 may include a grid blower 280a, 280b to cool grid resistor 270. Grid blower 280a may be electrically connected directly to resistive grid 260, such that grid blower 280a may draw current from converter output 250. Additionally or alternatively, grid blower 280b may be electrically connected to direct-current power bus 220, such that grid blower 280b may draw current from direct-current power bus 220.

Grid blower 280a, 280b may be configured in different ways to cool resistive grid 260. For example, grid blower 280a, 280b may be configured to operate when traction motor 130 is operating in a dynamic braking mode. Additionally or alternatively, grid blower 280a, 280b may be configured to operate at different power modes. According to some embodiments, grid blower 280a, 280b may be configured to operate as a function of the temperature of resistive grid 260. For example, grid blower 280a, 280b may operate at a lower mode when the resistive grid temperature is below a threshold temperature and at a higher mode when resistive grid temperature is above a threshold temperature.

A tap 290 may be electrically connected to resistive grid 260 to draw the direct current outputted by converter output 250. According to some embodiments, tap 290 may be electrically connected in parallel to grid resistor 270 of resistive grid 260. In this manner, tap 290 may draw current from converter output 250, consistent with principles of electricity like Kirchoff's current law and Kirchoff's voltage law. Tap 290 may be configured to draw less than all of the current output by converter output 250. The output of tap 290 may be electrically connected to direct-current power bus 220. Tap may be electrically coupled in parallel between grid resistor 270 and direct current power bus 220. In this manner, direct-current power bus 220 may draw current from tap 290 such that the direct-current power bus 220 may include the sum of the current from engine 140 and tap 290.

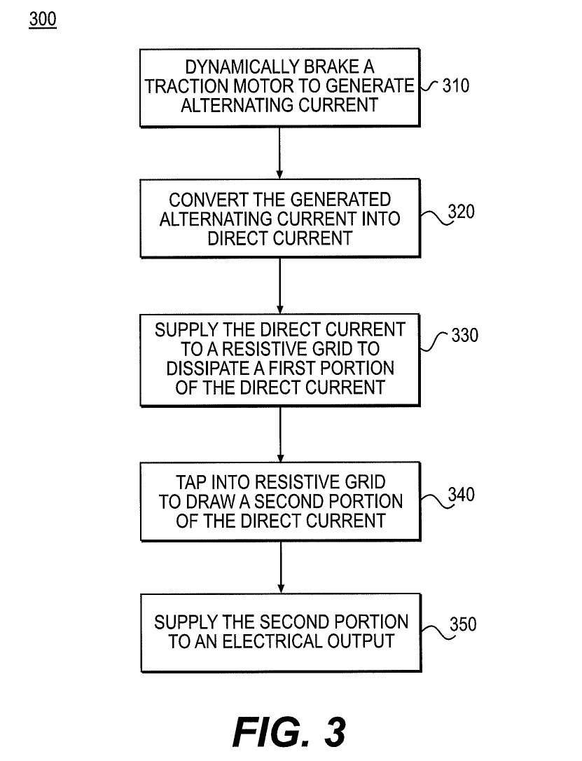

FIG. 3 illustrates a method 300 for using the current produced by traction motor 130 in dynamic braking mode to power auxiliary load 230 of locomotive 100. At step 310, method 300 may include dynamically braking traction motor 130. This may result in an alternating current. For example, step 310 may include operating traction motor 130 in dynamic braking mode. In this mode, traction motor 130 may include generating a three-phase alternating current.

At step 320, method 300 may include converting the generated alternating current into direct current. For example, step 320 may include operating converter 240 to convert the three-phase alternating current produced by traction motor 130 during step 310 into a direct current.

At step 330, the direct current from converter 240 may be supplied to resistive grid 260. Resistive grid 260 may dissipate a first portion of the direct current as it travels through resistive grid 260. For example, resistive grid 260 may be electrically connected to converter output 250 of converter 240 to draw direct current from converter 240.

At step 340, method 300 may include tapping into resistive grid 260 to draw a second portion of the direct current. For example, tap 290 may be electrically connected in parallel to resistive grid 260. At step 350, method 300 may include supplying the second portion of the direct current from tap 290 to an electrical output. For example, tap 290 may be electrically connected to direct-current power bus 220.

### INDUSTRIAL APPLICABILITY

The disclosed system and methods provide a robust solution for using the power generated by traction motors during braking of the locomotive. The presently disclosed regenerative braking systems and methods may have several advantages. While other systems provide a solution for powering only the grid blower, the disclosed systems provides a solution by which the generated electricity feeds directly into the DC bus for powering accessory loads.

It will be apparent to those skilled in the art that various modifications and variations can be made to the systems for regenerative dynamic braking and associated methods for operating the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A regenerative braking system comprising:
a converter having a converter output and a converter input, the converter input electrically connected to a traction motor;
a resistive grid electrically connected to the converter output, the resistive grid including at least one grid resistor; and
a tap electrically coupled in parallel between the at least one grid resistor and a direct-current power bus.

2. The system of claim 1, wherein the traction motor is configured to generate a three-phase alternating current when the traction motor is in a dynamic braking mode.

3. The system of claim 1, further including a grid blower.

4. The system of claim 3, wherein the grid blower is electrically connected to the direct-current power bus.

5. The system of claim 4, wherein the grid blower is electrically connected directly to the resistive grid.

6. The system of claim 1, wherein the direct-current power bus is configured to supply power to an auxiliary load.

7. The system of claim 1, wherein the direct-current power bus is configured to draw power from a locomotive engine.

8. A locomotive comprising:
an axle;
a pair of wheels connected to the axle;
a traction motor rotatably coupled to the axle; and
a regenerative braking system including:
a converter having a converter output and a converter input, the converter input electrically connected to the traction motor;
a resistive grid electrically connected to the converter output, the resistive grid including at least one grid resistor; and
a tap electrically coupled in parallel between the at least one grid resistor and a direct-current power bus.

9. The locomotive of claim 8, further including an engine configured to supply power to the traction motor.

10. The locomotive of claim 9, wherein the direct-current power bus is configured to draw power from the engine.

11. The locomotive of claim 10, wherein the direct-current power bus is electrically connected to an auxiliary rectifier to convert an alternating current from the locomotive engine into a second direct current.

12. The locomotive of claim 8, wherein the traction motor is configured to generate a three-phase alternating current when the traction motor is in a dynamic braking mode.

13. The locomotive of claim 8, further including a grid blower.

14. The locomotive of claim 13, wherein the grid blower is electrically connected to the direct-current power bus.

15. The locomotive of claim 13, wherein the grid blower is electrically connected directly to the resistive grid.

16. The locomotive of claim 13, wherein the grid blower is configured to operate as a function of the temperature of the resistive grid.

17. The locomotive of claim 8, wherein the direct-current power bus is configured to supply power to an auxiliary load.

18. The locomotive of claim 17, wherein the auxiliary load includes at least one of an engine cooling system and a locomotive control system.

19. The locomotive of claim 8, wherein the regenerative braking system is configured to supply direct current to the direct-current power bus.

20. A method comprising:
dynamically braking a traction motor, thereby resulting in an alternating current;
converting the alternating current into a direct current;
supplying the direct current to a resistive grid to dissipate a first portion of the direct current;
tapping into the resistor grid to draw a second portion of the direct current; and
supplying the second portion of the direct current to an electrical output.
